(19) United States
(12) Patent Application Publication
(10) Pub. No.: US 2015/0181476 A1
(43) Pub. Date: Jun. 25, 2015

(54) BATON HANDOVER TRANSITION FOR SINGLE RECEIVER USER EQUIPMENT

(71) Applicant: QUALCOMM Incorporated, SAN DIEGO, CA (US)

(72) Inventors: Ming YANG, San Diego, CA (US); Tom CHIN, San Diego, CA (US); Guangming SHI, San Diego, CA (US)

(73) Assignee: QUALCOMM Incorporated, SAN DIEGO, CA (US)

(21) Appl. No.: 14/139,718

(22) Filed: Dec. 23, 2013

(51) Int. Cl. H04W 36/00; H04W 72/08; H04W 16/14

(52) U.S. Cl. CPC H04W 36/0061; H04W 16/14; H04W 72/08; H04W 36/18

(57) ABSTRACT

In baton handover in TD-SCDMA communications, a user equipment (UE) may use of a single receiver to reduce call drops during baton handover. Following uplink handover, the UE may simultaneously receive downlink communication from a target cell and a source cell when a condition is satisfied. If the UE measures a signal quality of the downlink communication of the target cell greater than a signal quality of the downlink communication of the source cell, the UE switches to the target cell and completes the handover. If the UE measures a signal quality of the downlink communication of the source cell greater than a signal quality of the downlink communication of the target cell, the UE returns the uplink to the source cell and terminates the handover. Thus the UE may avoid handover to a target cell with poor signal quality.

### TECHNICAL FIELD

Aspects of the present disclosure relate generally to wireless communication systems, and more particularly, to avoiding call drop during baton handover for a single receiver user equipment.

### BACKGROUND

Wireless communication networks are widely deployed to provide various communication services such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method for wireless communication during a baton handover in a single receiver user equipment (UE) includes switching uplink communications from a source cell to a target cell while maintaining downlink communications at the source cell during the baton handover. The method also includes monitoring the downlink communications for both the target cell and the source cell during the baton handover when a condition is satisfied.

According to another aspect of the present disclosure, an apparatus for wireless communication during a baton handover in a single receiver user equipment (UE) includes means for switching uplink communications from a source cell to a target cell while maintaining downlink communications at the source cell during the baton handover. The apparatus also includes means for monitoring the downlink communications for both the target cell and the source cell during the baton handover when a condition is satisfied.

According to one aspect of the present disclosure, an apparatus for wireless communication during a baton handover in a single receiver user equipment (UE) includes a memory and a processor(s) coupled to the memory. The processor(s) is configured to switch uplink communications from a source cell to a target cell while maintaining downlink communications at the source cell during the baton handover. The processor(s) is also configured to monitor the downlink communications for both the target cell and the source cell during the baton handover when a condition is satisfied.

According to one aspect of the present disclosure, a computer program product for wireless communications in a wireless network during a baton handover in a single receiver user equipment (UE) in a wireless network includes a computer readable medium having non-transitory program code recorded thereon. The program code includes program code to switch uplink communications from a source cell to a target cell while maintaining downlink communications at the source cell during the baton handover. The program code also includes program code to monitor the downlink communications for both the target cell and the source cell during the baton handover when a condition is satisfied.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIGS. 4 and 5 are call-flow diagrams of a baton handover procedure.

FIG. 6 illustrates a method for improved baton handover according to one aspect of the present disclosure.

FIG. 7 is a diagram illustrating an example of a hardware implementation for an apparatus employing a processing system.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

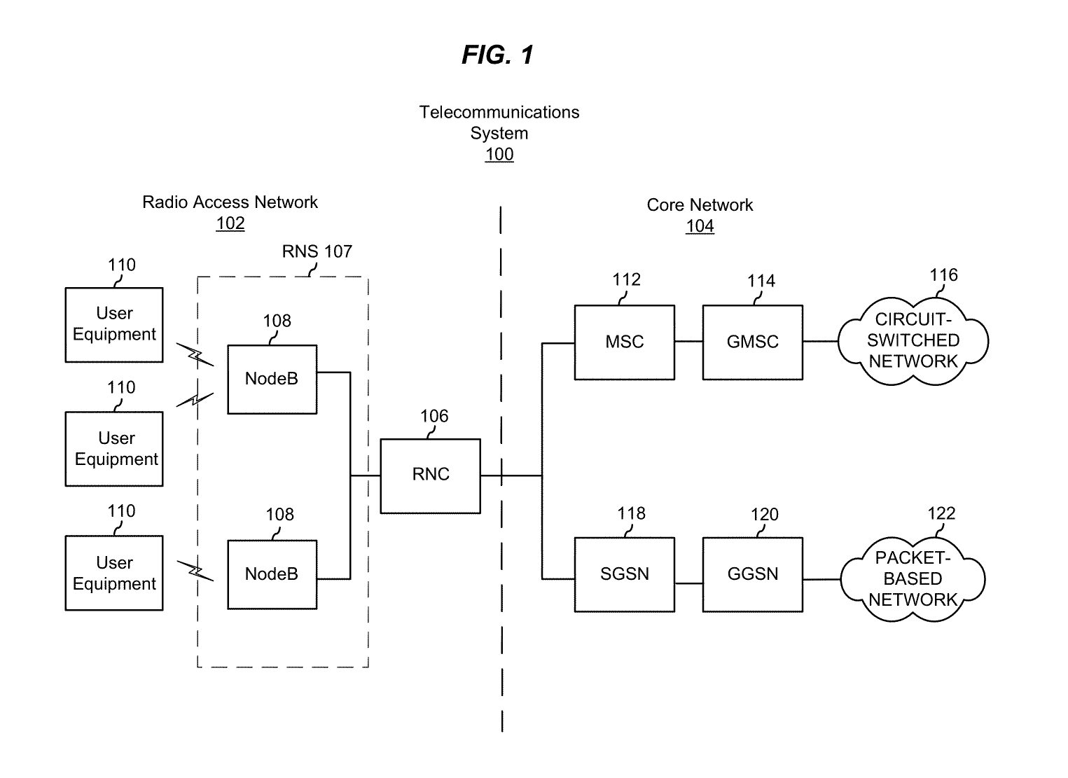

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC) such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving general packet radio service (GPRS) support node (SGSN) 118 and a gateway GPRS support node (GGSN) 120. GPRS is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum Direct-Sequence Code Division Multiple Access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

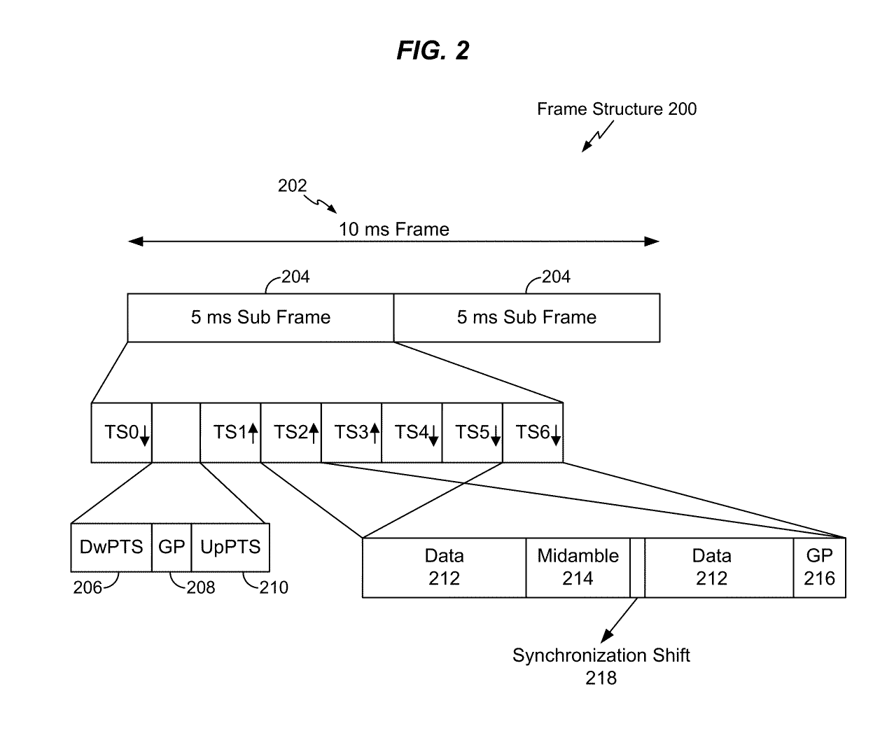

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including Synchronization Shift (SS) bits 218. Synchronization Shift bits 218 only appear in the second part of the data portion. The Synchronization Shift bits 218 immediately following the midamble can indicate three cases: decrease shift, increase shift, or do nothing in the upload transmit timing. The positions of the SS bits 218 are not generally used during uplink communications.

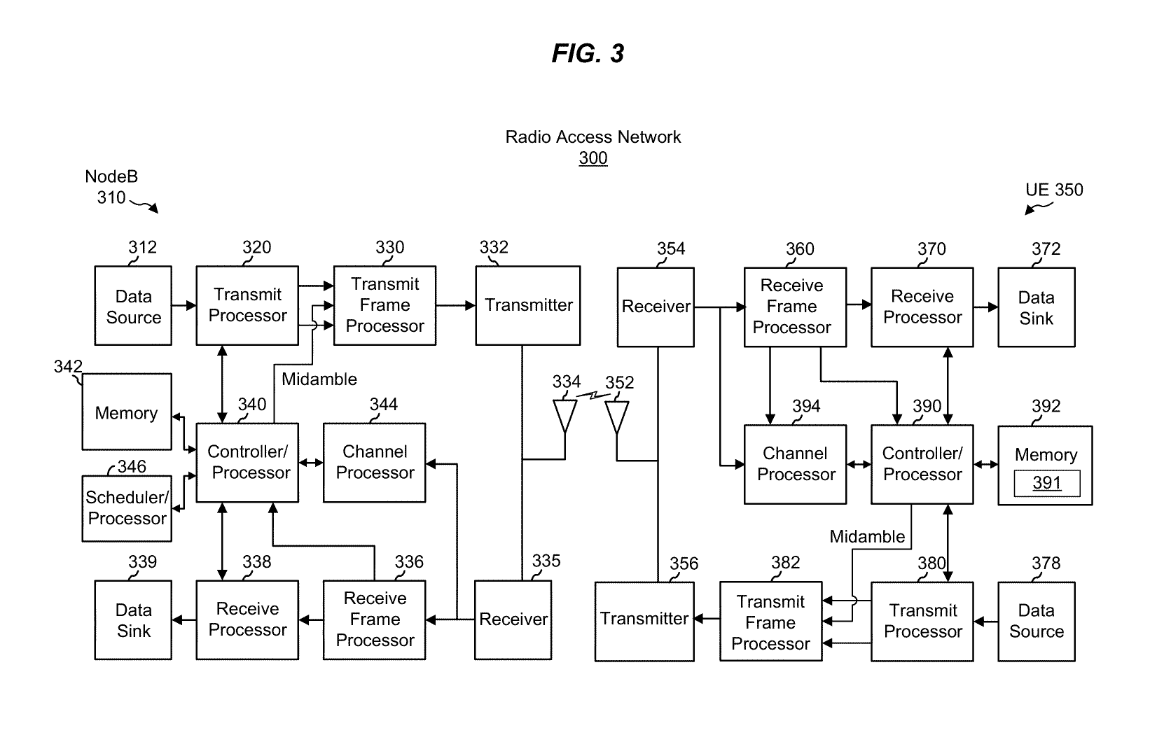

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receiver processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store a baton handover module 391 which, when executed by the controller/processor 390, configures the UE 350, during baton handover, to perform baton handover for a single receiver UE. A scheduler/processor 346 at the node B 310 may be used to allocate resources to the UEs and schedule downlink and/or uplink transmissions for the UEs.

### Baton Handover Transition for Single Receiver User Equipment

One feature of a time division-synchronous code division multiple access (TD-SCDMA) network is the baton handover, which is widely deployed in certain networks. For a baton handover, upon receiving the handover command from the source node B, the UE first switches its uplink (UL) communications from the source node B to the target node B. The UE also sends the target node B a special burst that can help the target node B acquire the uplink and establish downlink (DL) beamforming based on the uplink measurements. The downlink beamforming assists with communications from the target node B to the UE. Once uplink communications have been handed over, the UE switches its downlink communications to the target node B.

During a transition period between uplink handover and downlink handover, the UE receives downlink communications from the source cell and sends uplink communications to the target cell. To manage this transition period, a handover timer begins upon handover of the uplink communications. As presently indicated in the TD-SCDMA specification, this handover timer (also called the fixed downlink baton handover uplink to downlink switch timer) is 80 ms long. After the handover timer expires (i.e., after 80 ms), the UE switches the downlink communications to the target cell. In accordance with certain specifications, during the transition period, the network sends downlink communication (e.g., downlink data) to both the source and target cells after sending the handover command to the UE. As the handover command may take some time to reach the UE, sending data for the UE to both the source and target node Bs makes it more likely that the data finds its way to the UE regardless of where the UE is in its handover procedure. After the network receives the indication that the handover procedure to the target cell is complete, the network proceeds to only send downlink communication for the UE to the target cell. If, however, the network receives a handover failure indication from the source cell, the network proceeds to only send downlink communication for the UE to the source cell. In this case, the UE does not complete the handover procedure and has, for purposes of the network, reverted to the source cell.

The TD-SCDMA handover trigger is based on a primary frequency. For example, the handover trigger may be based on a primary frequency primary common control physical channel (PCCPCH) received signal code power (RSCP) measurement of the source and the target cells. The PCCPCH RSCP is mainly determined by path loss, i.e., the distance between the node B and the UE.

During handover, the UE may actually handover to any working frequency of the target cell. The working frequency of the target cell may be the primary frequency of the target cell, but in some cases is not the primary frequency. During handover, the UE does not consider the traffic time slot signal-to-noise ratio (SNR)/signal-plus-interference-to-noise ratio (SINR) of the particular frequency of the target cell. This behavior may result in the UE performing a baton handover to a target cell working frequency when the traffic time slots allocated to the working frequency have strong interference, even though the primary frequency has a good received signal code power. During the handover transition, without closed loop power control and timing control to adapt to radio frequency (RF) variations, communication information (e.g., data) may be lost during transition. If a UE attempts handover to a target frequency with poor performance, handover failure and/or call drop may result.

To address this problem and to reduce the number of call drops, proposed is a new scheme for a user equipment with a single receiver to avoid downlink communication loss during a baton handover transition period. Although the proposed scheme is described with respect to a single receiver UE, the proposed scheme may also apply to a UE with multiple receiver capability.

In one aspect of the present disclosure, the UE commences baton handover by commencing uplink handover when an activation time (indicated in handover command) to begin baton handover is received by the UE. For example, the UE switches the uplink (UL) to the target cell when the activation time (as indicated in the handover command) arrives. For uplink communications, the UE may buffer the data and send a special burst to the target cell during handover transition. For example, if the UE is involved in a data call, during the baton handover, instead of sending regular data, the UE sends a special burst (SB) while the regular data is buffered. Communication of normal data is only resumed once the handover process is complete (resulting in either a good connection with the target cell or resumed communications with the source cell). In this manner, data loss may be avoided should the baton handover prove unsuccessful.

The UE may also attempt to receive downlink communication from both the source and target cells when a condition for improved baton handover is satisfied. The condition may be satisfied when the source and target cells are at a same working frequency. The condition may also be satisfied when the working frequencies are different and the downlink communications from the source cell arrive at different times than the downlink communications from the target cell. For example, the condition is satisfied when there are one or more time slots of spacing between a downlink time slot of the source cell and a downlink time slot of the target cell. The one or more time slot spacing allows the single UE receiver time to tune between the different working frequencies of the source cell and the target cell to perform channel measurements.

When the condition for improved baton handover is satisfied, the UE receives downlink communication from both the source and target cells simultaneously during handover transition. The UE may select the downlink communications from the source cell or the target cell for further processing, such as forwarding the selected downlink communication to an upper layer. The selection may be based on a determination of whether the source cell or the target cell has better reception. To determine whether the source or target cell has better reception, the UE monitors and/or measures the downlink communications for both the target cell and the source cell during the baton handover.

The downlink communication of the target cell or the source cell is determined to be better based on measurement (e.g., signal quality measurement) of the downlink signal from the target and the source cells. The UE compares the signal quality of the target cell to the signal quality of the source cell. The signal quality may be based on a measurement of signal to noise ratio (SNR), signal plus interference to noise ratio (SINR), RSCP, or other metric.

The UE processes the downlink communications from the cell with better reception during a baton handover transition period. For example, if the signal quality of the target cell is better than the signal quality of the source cell, the UE stops downlink reception from the source cell, and only performs downlink reception from the target cell prior to and/or after expiration of the fixed timer. Otherwise, if the signal quality of the target cell is worse than the signal quality of the source cell, the UE continues receiving downlink communications from both the source and the target cells. As noted, when the condition for improved baton handover is satisfied, the UE receives downlink communications from both the source and target cells simultaneously during handover transition. Otherwise, the UE continues receiving downlink communications only from the source cell.

In some aspects of the disclosure, the baton handover is aborted when the source cell has better reception. The timing of completion of the handover may be adjusted based on the determination of whether the source cell or target cell has better reception. For example, the time of completion of the baton handover may be delayed when the source cell has better reception. The time for completion of the baton handover may also be adjusted by expediting completion of the baton handover when the target cell has better reception.

Upon expiration of a maximum allowed timer for completing the baton handover procedure, the UE may switch communication back to the source cell. For example, the UE may switch transmission (TX) back to the source cell and discontinue downlink reception from the target cell. The UE then sends handover failure information to the source cell, and communicates with the source cell only.

If the condition is not satisfied, the UE performs a non-optimized or normal baton handover, where the UE attempts to receive downlink communication from either the source or target cell. For example, when the working frequency of the source cell is different from the working frequency of the target cell and there is not enough time for the single receiver to switch between the different working frequencies, a normal baton handover procedure is performed. In the normal baton handover, the UE may only receive downlink communication from the source cell.

Aspects of the present disclosure allow the UE to avoid handing over to frequencies and time slots with high interference. This reduces and/or avoids downlink package loss during transition.

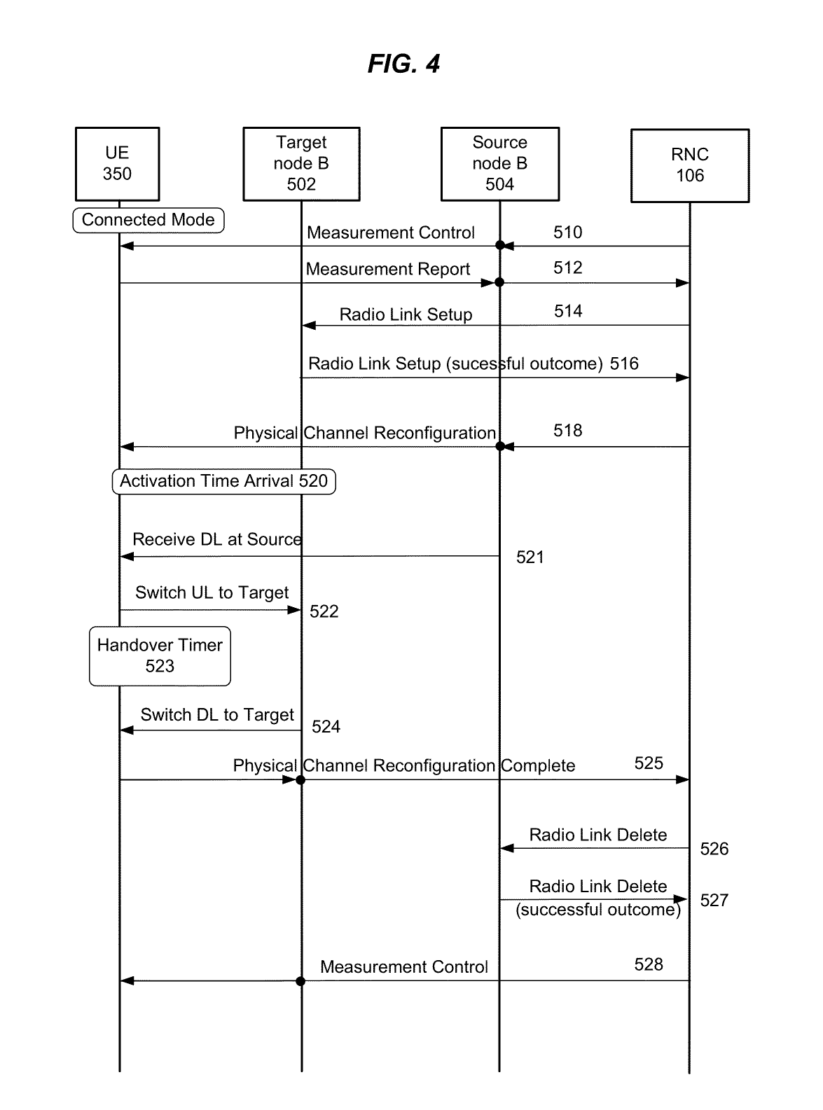

FIG. 4 illustrates a call-flow of a baton handover procedure. The UE 350 is in a call in a connected mode with the source node B 504. During the call, the Radio Network Controller (RNC) 106 initiates a measurement control message at time 510 to be sent to the UE 350 through the source node B 504. In response to the measurement control message, the UE 350 measures neighboring potential target cells and reports those measurements in a measurement report, at time 512. The measurement report may be sent to the RNC 106 through the source node B. Based on the measurements obtained by the UE 350, the RNC 106 identifies a target node B 502 as the target cell for the UE 350 during the baton handover. The RNC 106 and the target node B 502 then perform a radio link setup exchange at times 514 and 516. The RNC 106 then initiates a physical channel reconfiguration (i.e., handover) message at time 518 to be sent to the UE 350 through the source node B 504. The physical channel reconfiguration message includes the identity of the target node B 502 as well as the activation time.

Upon arrival of the activation time 520, the UE 350 commences baton handover. With the baton handover triggered, the downlink communication, at time 521, remains with the source node B 504. However, the uplink communication, at time 522, is switched to the target node B 502. In some configurations, switching communication (UL/DL) may be in accordance with a working frequency rather than a primary frequency.

To manage the transition period between uplink handover and downlink handover, a handover timer at time 523 begins upon handover of the uplink communications. As noted, this handover timer may be 80 ms long in some specifications. After the handover timer expires, the UE 350 switches the downlink communications to the target cell at time 524. At time 525, the UE 350 then sends a physical channel reconfiguration (i.e., handover) complete message to the RNC 106 through the target node B 502. The RNC 106 and source node B 504 then complete a radio link delete exchange at times 526 and 527 for communications of the UE 350, thereby completing the handover. At time 528, the Radio Network Controller (RNC) 106 initiates a measurement control message to be sent to the UE 350 through the target node B 502.

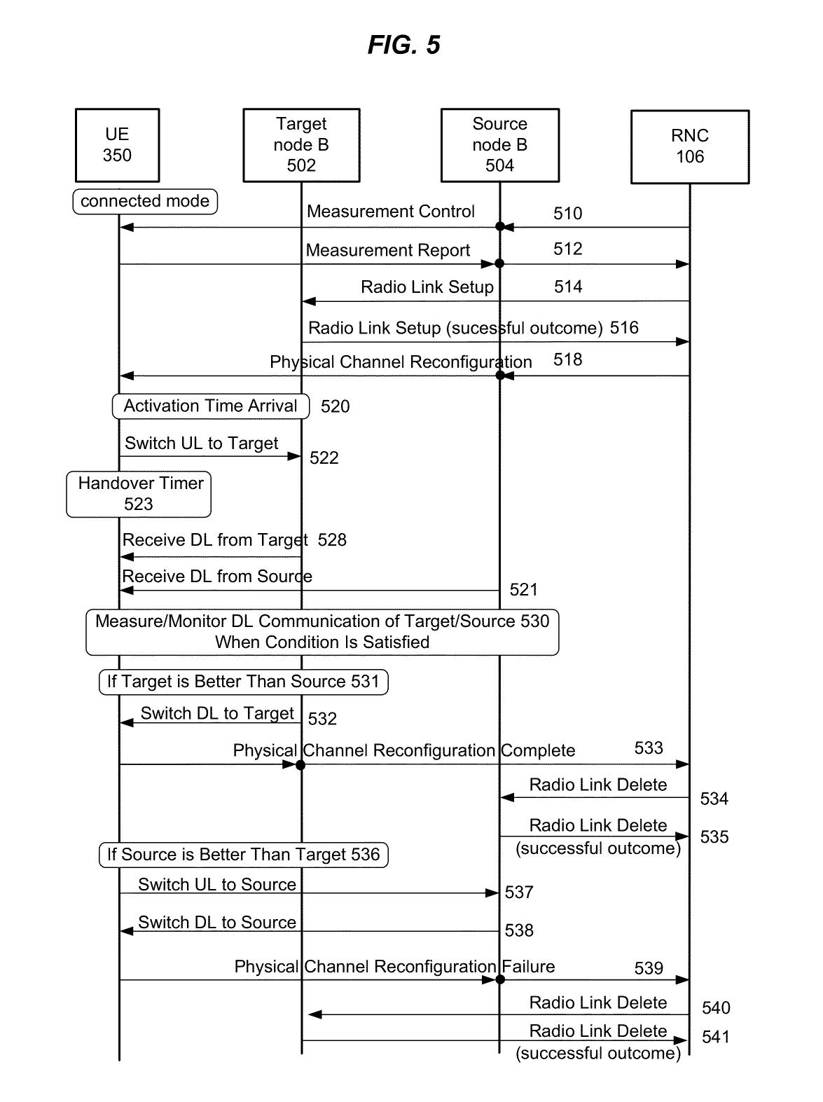

FIG. 5 illustrates a call-flow of a baton handover procedure according to some aspects of the present disclosure. More details of the baton handover sequence of FIG. 4 after the activation time 520 are illustrated in FIG. 5. As noted, the UE 350 commences baton handover by commencing uplink handover when an activation time (indicated in the handover command) to begin baton handover is received by the UE. At time 522, the UE 350 switches the uplink (UL) to the target cell/node B 502 when the activation time (indicated in handover command) arrives. The handover timer at time 523 begins upon handover of the uplink communications (i.e., when the uplink switches to target node B 502).

The UE 350 simultaneously receives downlink communication from both the source and target cells when the condition for improved baton handover is satisfied. For example, the UE 350 receives downlink communication from the target node B 502 at time 528 and receives downlink communication from the source node B 504, at time 521 when the condition is satisfied. The condition is satisfied when the target cell and source cell working frequencies are the same or when there is sufficient time to switch from the source cell to the target cell for measurements.

At time 530, the UE 350 may monitor and/or measure the signal quality of the downlink communications for both the target cell and the source cell during the baton handover when the condition is satisfied. The result of the signal quality measurement may determine whether the downlink communication from the target node B 502 or the source node B 504 is better.

At time 531, if the downlink communication received at the UE 350 from the target node B 502 is of better quality than the downlink communication received at the UE 350 from the source node B 504, the UE 350 switches the downlink communication to the target node B 502 at time 532. At time 533, the UE 350 sends a physical channel reconfiguration (i.e., handover) complete message to the RNC 106 through the target node B 502. The RNC 106 and the source node B 504 then complete a radio link delete exchange at times 534 and 535 for communications of the UE 350, thereby completing the handover.

At time 536, if the downlink communication received at the UE 350 from the target node B 502 is of lesser quality than the downlink communication received from the source node B 504, the UE 350 switches its uplink back to the source node B 504 at time 537. The UE 350 then switches the downlink communication to the source node B 502 at time 538. The UE 350 then sends a physical channel reconfiguration failure message at time 539 to the RNC 106 through the source node B 504. The RNC 106 and target node B 502 then complete a radio link delete exchange at times 540 and 541 for communications of the UE 350, thereby terminating the handover.

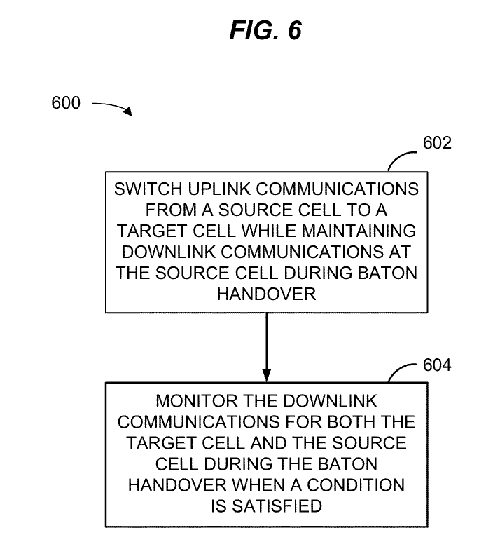

FIG. 6 shows an example of a wireless communication method 600 that may be used by the controller/processor 390 of the UE 350 during baton handover. A UE switches uplink communications from a source cell to a target cell while maintaining downlink communications at the source cell during the baton handover, as shown in block 602. The UE then monitors the downlink communications for both the target cell and the source cell during the baton handover when a condition is satisfied, as shown in block 604. The condition for monitoring both the source and target cells is satisfied when the source and target cells are at a same working frequency. The condition may also be satisfied when the working frequencies are different and the downlink communications from the source cell arrive at different times than downlink communications from the target cell so that a UE receiver has time to tune between the different working frequencies.

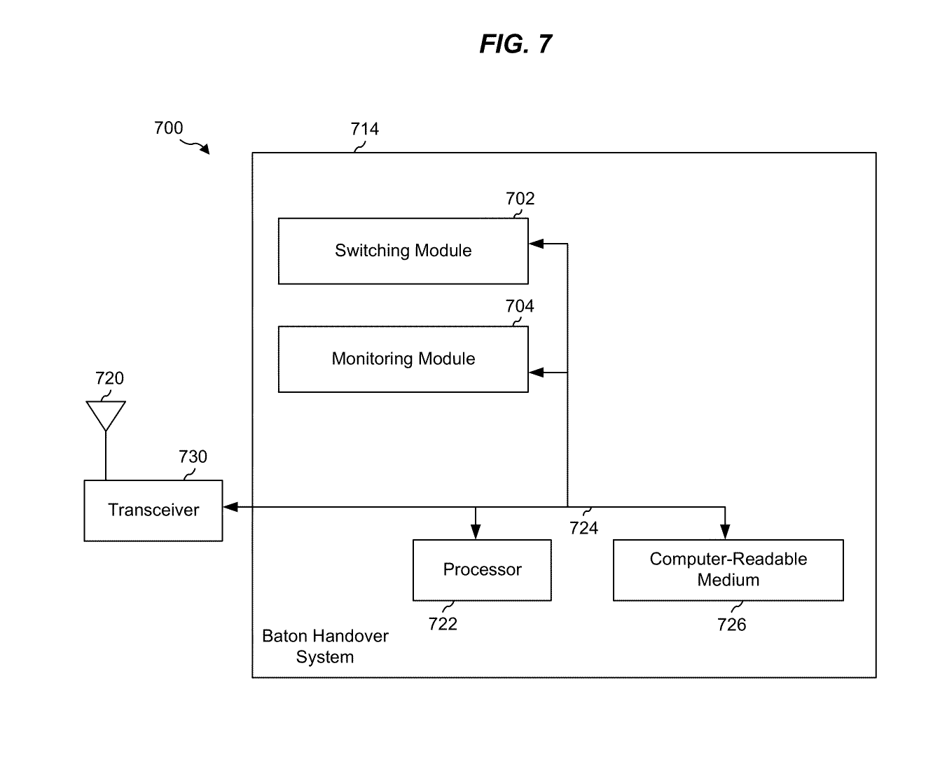

FIG. 7 is a diagram illustrating an example of a hardware implementation for an apparatus 700 employing a baton handover system 714. The baton handover system 714 may be implemented with a bus architecture, represented generally by the bus 724. The bus 724 may include any number of interconnecting buses and bridges depending on the specific application of the baton handover system 714 and the overall design constraints. The bus 724 links together various circuits including one or more processors and/or hardware modules, represented by the processor 722, the switching module 702, the monitoring module 704, and the computer-readable medium 726. The bus 724 may also link various other circuits such as timing sources, peripherals, voltage regulators, and power management circuits, which are well known in the art, and therefore, will not be described any further.

The apparatus includes a baton handover system 714 coupled to a transceiver 730. The transceiver 730 is coupled to one or more antennas 720. The transceiver 730 enables communicating with various other apparatus over a transmission medium. The baton handover system 714 includes a processor 722 coupled to a computer-readable medium 726. The processor 722 is responsible for general processing, including the execution of software stored on the computer-readable medium 726. The software, when executed by the processor 722, causes the baton handover system 714 to perform the various functions described for any particular apparatus. The computer-readable medium 726 may also be used for storing data that is manipulated by the processor 722 when executing software.

The baton handover system 714 includes a switching module 702 for switching uplink communications from a source cell to a target cell while maintaining downlink communications at the source cell during the baton handover. The baton handover system 714 also includes a monitoring module 704 for monitoring the downlink communications for both the target cell and the source cell during the baton handover when a condition is satisfied. The modules may be software modules running in the processor 722, resident/stored in the computer-readable medium 726, one or more hardware modules coupled to the processor 722, or some combination thereof. The baton handover system 714 may be a component of the UE 110/350 and may include the memory 392, and/or the controller/processor 390.

In one configuration, an apparatus such as a UE 110/350 is configured for wireless communication including means for switching. In one aspect, the means may be the antennas 352, 720 the receiver 354, the transceiver 730, the transmitter 356, the controller/processor 390, the memory 392, baton handover module 391, switching module 702 and/or the baton handover system 714 configured to perform the means. In one aspect the means functions recited by the aforementioned means. In another aspect, the aforementioned means may be a module or any apparatus configured to perform the functions recited by the aforementioned means.

The UE is also configured to include means for monitoring. In one aspect, the means may be the receive processor 370, the transmit processor 380, the controller/processor 390, the memory 392, the antennas 352, 720, the receiver 354, the transmitter 356, the transceiver 730, baton handover module 391, monitoring module 704, and/or the baton handover system 714 configured to perform the tuning means. In one aspect the means functions recited by the aforementioned means. In another aspect, the aforementioned means may be a module or any apparatus configured to perform the functions recited by the aforementioned means.

Several aspects of a telecommunications system has been presented with reference to 3GPP in general, and to TD-SCDMA in particular. As those skilled in the art will readily appreciate, various aspects described throughout this disclosure may be extended to other telecommunication systems, network architectures and communication standards. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing global system for mobile communications (GSM), long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication during a baton handover in a single receiver user equipment (UE), comprising:
switching uplink communications from a source cell to a target cell while maintaining downlink communications at the source cell during the baton handover; and
monitoring the downlink communications for both the target cell and the source cell during the baton handover when a condition is satisfied.

2. The method of claim 1, in which the condition is satisfied when the source and target cells are at a same working frequency or when the working frequencies are different and the downlink communications from the source cell arrive at different times than the downlink communications from the target cell so that a UE receiver has time to tune between the different working frequencies.

3. The method of claim 1, further comprising:
determining whether the source cell or target cell has better reception; and
processing the downlink communications from the cell with better reception during a baton handover transition period.

4. The method of claim 3, further comprising aborting the baton handover when the source cell has better reception.

5. The method of claim 3 further comprising adjusting a timing of completion of the baton handover based on the determining.

6. The method of claim 5, in which adjusting comprises delaying completion of the baton handover when the source cell has better reception.

7. The method of claim 5, in which adjusting comprises expediting completion of the baton handover when the target cell has better reception.

8. The method of claim 1, further comprising performing a normal baton handover when the condition is not satisfied.

9. An apparatus for wireless communication during a baton handover in a single receiver user equipment (UE), comprising:
means for switching uplink communications from a source cell to a target cell while maintaining downlink communications at the source cell during the baton handover; and
means for monitoring the downlink communications for both the target cell and the source cell during the baton handover when a condition is satisfied.

10. The apparatus of claim 9, in which the condition is satisfied when the source and target cells are at a same working frequency or when the working frequencies are different and the downlink communications from the source cell arrive at different times than the downlink communications from the target cell so that a UE receiver has time to tune between the different working frequencies.

11. An apparatus for wireless communication during a baton handover in a single receiver user equipment (UE), comprising:
a memory; and
at least one processor coupled to the memory and configured:
to switch uplink communications from a source cell to a target cell while maintaining downlink communications at the source cell during the baton handover; and
to monitor the downlink communications for both the target cell and the source cell during the baton handover when a condition is satisfied.

12. The apparatus of claim 11, in which the condition is satisfied when the source and target cells are at a same working frequency or when the working frequencies are different and the downlink communications from the source cell arrive at different times than the downlink communications from the target cell so that a UE receiver has time to tune between the different working frequencies.

13. The apparatus of claim 11, in which the at least one processor is further configured:
to determine whether the source cell or target cell has better reception; and
to process the downlink communications from the cell with better reception during a baton handover transition period.

14. The apparatus of claim 13, in which the at least one processor is further configured to abort the baton handover when the source cell has better reception.

15. The apparatus of claim 13, in which the at least one processor is further configured to adjust a timing of completion of the baton handover based on the determining.

16. The apparatus of claim 15, in which the at least one processor is further configured to adjust by delaying completion of the baton handover when the source cell has better reception.

17. The apparatus of claim 15, in which the at least one processor is further configured to expedite completion of the baton handover when the target cell has better reception.

18. The apparatus of claim 11, in which the at least one processor is further configured to perform normal baton handover when the condition is not satisfied.

19. A computer program product for wireless communications in a wireless network during a baton handover in a single receiver user equipment (UE), comprising:
a non-transitory computer-readable medium having program code recorded thereon, the program code comprising:
program code to switch uplink communications from a source cell to a target cell while maintaining downlink communications at the source cell during the baton handover; and
program code to monitor the downlink communications for both the target cell and the source cell during the baton handover when a condition is satisfied.

20. The computer program product of claim 19, in which the condition is satisfied when the source and target cells are at a same working frequency or when the working frequencies are different and the downlink communications from the source cell arrive at different times than the downlink communications from the target cell so that a UE has time to tune between the different working frequencies.
